(19) United States
(12) Patent Application Publication
(10) Pub. No.: US 2021/0289956 A1
(43) Pub. Date: Sep. 23, 2021

(54) System to Enhance Display Racks

(71) Applicant: Royal Consumer Products LLC, Norwalk, CT (US)

(72) Inventor: Gregory Kane, Fairfield, CT (US)

(73) Assignee: Royal Consumer Products LLC, Norwalk, CT (US)

(21) Appl. No.: 17/005,785

(22) Filed: Aug. 28, 2020

Related U.S. Application Data
(60) Provisional application No. 62/991,443, filed on Mar. 18, 2020.

(51) Int. Cl. A47F 5/00; G09F 3/20

(52) U.S. Cl. CPC A47F 5/0068; A47F 2005/0075; G09F 3/204

(57) ABSTRACT

A plastic rack sleeve that clips onto rack shelves of a wire display rack. The plastic rack sleeve has two strips separated from each other by a hinge. Each of the two strips has a set of clips that are complementary to the other's clips to engage when the plastic rack sleeve is pivoted about the hinge. One of the two strips has a central formation that projects outward and is defined by an upright surface and an inclined surface. A tag holder is integral to the upright surface to retain an identification tag or label.

### CROSS-REFERENCE TO RELATED APPLICATIONS

U.S. provisional patent application No. 62/991,443 filed Mar. 18, 2020 from which the present application asserts priority.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable

### BACKGROUND OF THE INVENTION

### (1) Field of the Invention

The invention pertains to plastic rack sleeves, which are fit over wire rack shelves of retailer wire display racks. The plastic rack sleeves may hold labels to identify the merchandize placed on the wire rack shelves.

### (2) Description of Related Art Including Information Disclosed Under 37 CFR 1.97 and 1.98

According to a website of Clip Strip Corp. at clipstrip.com/sign-holders-shelf-edge-ceiling-floor-wall-countertop-literature-pop-signage-hardware/wire-fixture-sign-label-holders.html:
Wire Shelving display units are very popular with businesses worldwide: retail stores use them for product displays, warehouses use them for inventory, and hospitals use them in supply rooms. Even offices use them in mail rooms and stock rooms. They are easy to assemble, durable and very affordable. Wire Shelving requires . . . signage adapters to make them fully functional Point of Purchase vehicles or organized storage systems . . . . [The signage adaptors include] retail sign holders and sign clips that specifically fit wire shelving's unique needs and label holders that will solve any retail, or storage labeling needed to get the most out of . . . wire shelving.

Conventionally, the assembly or substitution of label holders on wire rack shelves of retailer wire display racks require that the merchandize on display on the wire rack shelves be removed from slots where they reside. Such can be a time-consuming task to accomplish. Further, tools, may be needed to carry out the assembly. U.S. Pat. No. 6,659,294, which is directed to a multi-configurational wire rod display rack and whose contents are incorporated herein by reference, exemplify the assembly and structure of a conventional wire display rack with different kinds of rack shelves.

U.S. Pat. No. 5,921,412 exemplifies the use of a plastic label holder that is mounted in alignment with a product row onto a front bar. There are also snap on label holders, such as that shown in FIG. 6 herein, that are secured to the front of a product rows in wire rack shelves of a retailer wire display rack to identify merchandize on display on the product row. Retailers often want their wire display racks to take on a desired look or appearance, i.e., changing their color from time to time. These snap on label holders are too small to satisfy such a need. Thus, retailers are compelled to remove merchandize from the shelving and replace the shelving accordingly that have the color they desire—a time consuming and costly process.

It would be desirable to provide plastic rack sleeves designed to minimize the time and cost required to set-up, because merchandize on rack shelves won't need to be removed from the slots to effect assembly. Further, it is desired that the assembly of the plastic rack sleeves onto rack shelves or trays of the wire display rack avoid the use of tools.

### BRIEF SUMMARY OF THE INVENTION

One aspect of the invention relates to plastic rack sleeves each with multiple, such as four, locking clips to attach the plastic rack sleeve to the wire rack shelf or tray in a manner that minimizes their relative movement as the wire rack shelf or tray is handled by customers or staff. The plastic rack sleeves are fit over wire rack shelves or trays of retailer wire display racks.

This invention is applicable for all merchandize or products of any kind for all wire display racks and provides for an aesthetically pleasing rack (the shelves or trays would be painted the colors of the retailer or color scheme of their store). As compared to furnishing new wire display racks of similar appearance instead, the implementation of the plastic rack sleeves is faster and easier and the cost of the rack sleeves or trays is much less.

Further, product description/price tabs, which are built into the plastic rack sleeves, are easier to use & less costly than conventional systems for product and price identification. This allows for faster, easier product changes (as the tabs identify, i.e., to the customer and to the store managers, the products that go into each slot of each rack).

### BRIEF DESCRIPTION OF THE SEVERAL VIEWS OF THE DRAWING(S)

For a better understanding of the present invention, reference is made to the following description and accompanying drawings, while the scope of the invention is set forth in the appended claims.

FIG. 1 is an isometric front view of plastic rack sleeves shown upright in accordance with a first embodiment of the invention.

FIG. 2 is an isometric front view of plastic rack sleeves shown upright in accordance with a second embodiment of the invention.

FIG. 3 is an isometric view of a conventional wire display rack equipped with conventional rack shelves or trays and having in place plastic rack sleeves each in accordance with the first embodiment of FIG. 1.

FIG. 4 is an isometric view of a plastic rack sleeve of FIG. 2 being placed above (prior to folding) above a proximal end of a conventional rack shelf or tray, albeit a shorter conventional rack shelf or tray than that depicted in FIG. 3.

FIG. 5 is an isometric view of the plastic rack sleeve of FIG. 2 in position (after folding) onto the proximal end of the conventional rack shelf or tray of FIG. 4 and with a label in position.

FIG. 6 is an isometric view of a conventional snap-on label holder onto a conventional wire rack shelf.

### DETAILED DESCRIPTION OF THE INVENTION

Turning to the drawings, FIGS. 1-5 depict a plastic rack sleeve 10 that enhances a wire display rack 20 by being fitted onto the front of a rack shelf or tray 30. The plastic rack sleeve 10, which is elongated, has two strip portions 10A, 10C, a central hinge 10B separating the two strip portions 10A, 10C, four pairs of clip formations 12A, 12B that together constitute clips 12, and a product tag mount 14 that has an outward projecting surface 14A, an inclined surface 14B and two symmetric end surfaces 14C that define a recessed volume bounded by the outward projected surface 14A, the inclined surface 14B and the two symmetric end surfaces 14C. The two strip portions 10A, 10C and the hinge 10B all extend the full length of the plastic rack sleeve 10.

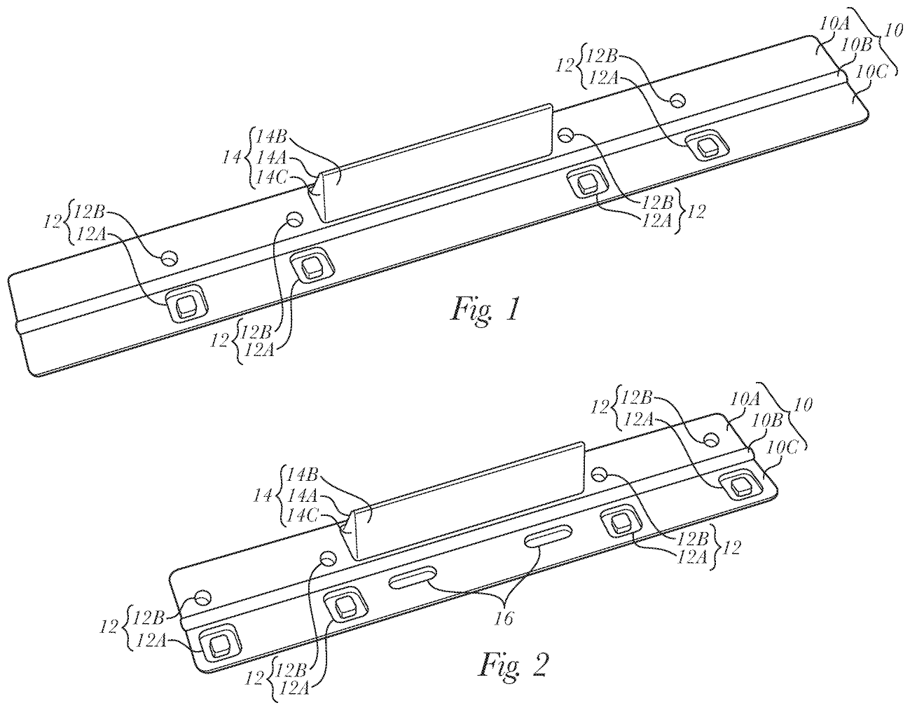

Turning to FIGS. 1 and 2, a pair of rack sleeves 10 are shown that are different embodiments—the shorter one is about 22 inches in length and the longer one is about 28 inches in length. The color of each rack sleeve arises from the resin; the sleeves are not painted. The color preferably corresponds to the retailer's preference and may be transparent or translucent instead if desired.

Also, as shown in FIG. 2, the rack sleeve 10 may have slots 16, which would communicate with the open space of the product tag mount 14 when the two strip formations 10A, 10C abut each other.

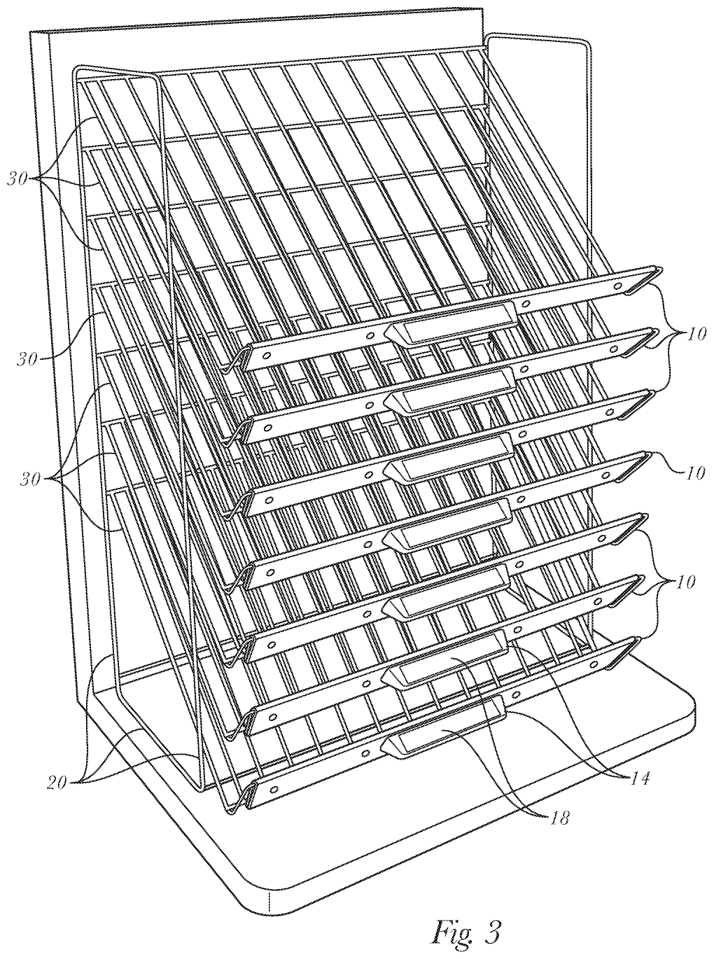

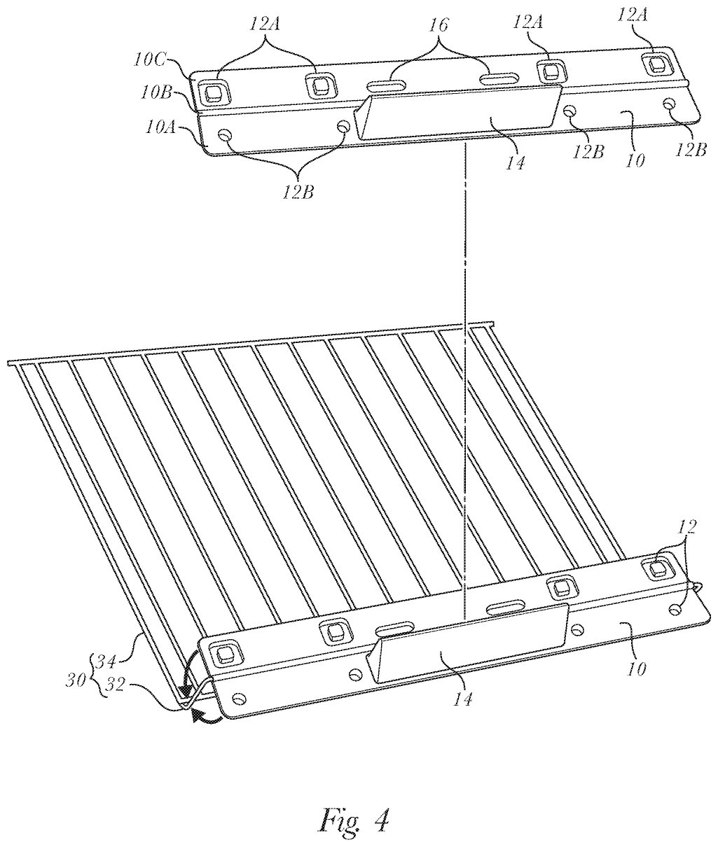

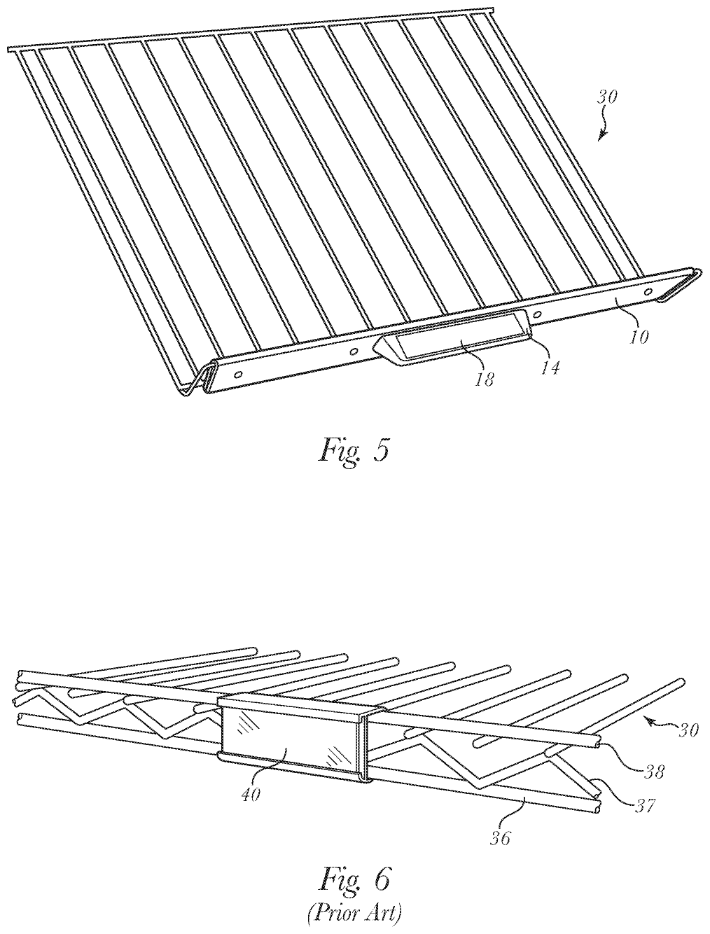

FIG. 3 also shows a conventional wire display rack 20 equipped with seven conventional wire rack shelves or trays 30, although conventional wire rack shelves typically have ten to twelve wire rack shelves or trays 30 but only seven are shown in FIG. 3 for the sake of convenience. FIGS. 4 and 5 show the manner of mounting the plastic rack sleeve 10 to the wire rack shelf or tray 30. FIG. 6 shows a conventional snap on mount to a wire rack shelf or tray 30.

As shown in FIG. 4, each rack sleeve 10 preferably has four clips 12 in the form of four pairs of complementary clip formations 12A, 12B. In order for each pair of complementary clip formations 12A, 12B to engage each other, the two strip portions 10A, 10C of the plastic sleeve 10 must be flexed about the hinge 10B to abut each other on either side of a front, upright portion 32 of a rack shelf or tray 30. After so doing, the clip formations 12A, 12B can engage and interlock each other. This is because the clip formations 12A of one of the two strip portions 10C are aligned with the clip formations 12B of a remaining one of the two strip portions 10A across the elongated hinge 10B and their respective centers are equidistant from a center line of the elongated hinge 10B.

While FIGS. 1A and 1B show the clip formations 12A being square male formations and the clip formations 1B being round female formations, both can be square or both can be round. Preferably, the outer periphery of the male formation is slightly wider than the inner periphery of the female formation to enable a friction fit between. Further, double-sided tape may be placed between the opposing sides of the two strip portions 10A, 10C that face each other when the clip formations 12A, 12B engage to adhere the two strip portions 10A, 10C to each other and thereby lessen the risk of the plastic sleeve 10 inadvertently disengaging or coming off the front, upright portion 32 of a rack shelf or tray 30.

The product tag mount 14 is a formation or structure in the central region of the strip portion 10A that projects outward from a neighboring planar region of the strip portion 10A. The product tag mount 14 has four surfaces: an inclined surface 14A, an outward projecting surface 14B and two symmetric end surfaces 14C. As a consequence, a recessed portion is bounded by the four surfaces.

A tag or label holder 18 is integrally formed in the outward projecting surface 14B of the product tag mount 14 or may be adhered to with double sided tape. The outward projecting surface 14B is supported by the inclined surface 14A of the product tag mount 14 and both meet each other at their proximal ends and are spaced apart from each other at their respective distal ends.

As can be appreciated from FIG. 3, the rack shelves or trays 30 are angled as they are held in place by the wire rack display 20 so that their front end is lower than their back end. It is conventional practice to apply a product tag holder to sit vertically on front end in the manner of FIG. 6.

The inventor has found that be angling product tag holder 18 because of its integration on the outward projecting surface 14B (FIGS. 1, 2, 3 and 5), enables the tag to be read easier by the consumer (and faster for the consumer to shop). The tag is positioned at the center of a product row that showcases products (after they are assembled into product rows in the rack shelves or trays 30). Such has the added advantage of helping to keep the wire display rack 20 neat and organized, easier for the store associate to fill and maintain the correct planogram and to update the color-coded product information/images tags more economically using the channel strips that are provided.

FIG. 3 shows the wire display rack 20 with the plastic rack sleeves 10 being vacuum-formed (or EAD plastic rack sleeves). The lightweight, easy to install plastic rack sleeves 10 improve the appearance of the wire rack display 20 by concealing the unsightly wire while still allowing the merchandize or product to move in and out of the slot. The depth and length will vary depending on the design of the existing wire fixture. The plastic rack sleeves 10 cover the length of the shelf board, which is on the leading edge, and such may help reduce store damages that occur over time as the shelf boards bounce against the naked wire and bend and tear the poster boards stored on them as the product.

FIGS. 4 and 5 illustrate the manner of securing a plastic rack sleeve 10 to an upright end 32 of a wire rack shelf or tray 30, with FIG. 4 representing the situation before folding the plastic rack sleeve 10 and FIG. 5 representing the situation after such folding and snapping the clips 12A, 12B closed. The product tag holder 18 is attached to the upright, vertical surface 32 of the wire rack shelf or tray 30 in a secure manner such as with an adhesive. The product tag holder 18 is configured to retain product tags or identifiers in position.

FIG. 6 shows a conventional manner of attaching a tag or label holder to a proximal end of a conventional shelf rack. In effect, the tag or label is positioned vertically, which renders it difficult for a consumer to read if such is located below the consumer's eye level.

The proximal end of the conventional shelf rack of FIG. 6 may be the same as that of the proximal ends of the shelf racks of FIGS. 3-5. It has an upright, vertical portion 32 with top and bottom wires that extend parallel to each other. A wire is bent multiple times between the bottom and top wires 36, 38 in a manner that forms gaps bounded on two sides by the bent wire 37 and by one of the top and bottom wires 36, 39.

The wire rack shelf 30 also has a base portion 32 of parallel wires that extends in a plane perpendicular to a plane that passes through the upright, vertical portion 32. A snap-on tag or label holder 40 is mounted onto the upright, vertical portion 32 in a manner so as to be parallel to that to that of the upright, vertical portion 32 (as opposed to being mounted in a non-parallel manner).

While the foregoing description and drawings represent the preferred embodiments of the present invention, it will be understood that various changes and modifications may be made without departing from the scope of the present invention.

What is claimed is:

1. A display rack enhancer, comprising:
a plastic sleeve that is elongated to define a full length, the plastic sleeve having a central hinge that extends the full length of the plastic sleeve, the plastic sleeve having two strips separated from each other by the central hinge and that each extend the full length of the plastic sleeve, the plastic sleeve being configured so that the two strips may pivot under manual force about the hinge into an abutting relation with each other,
wherein the two strips have pairs of clip formations that engage each other as the two strips reach the abutting relation with each other so that engaging the pairs of clip formations with each other in the abutting relation retains the two strips to each other;
wherein one of the two strips has a central formation and a neighboring planar region, the central formation projecting outward from the neighboring planar region to define a tag holder surface that is out of a plane passing through the neighboring planar region of the one of the two strips and that is configured to retain an identification tag or label in position in a releasable manner.

2. The display rack enhancer of claim 1, wherein one of the clip formations includes a central region and a recessed region surrounding the central region, the recessed region being recessed relative to that of the central region.

3. The display rack enhancer of claim 2, wherein a further of the clip formations includes a recess that fits about the central region after pivoting the two strips into the abutting relation.

4. The display rack enhancer of claim 3, wherein the central region and the recess are friction fit against each other.

5. The display rack enhancer of claim 1 in combination with the rack shelf or tray, the rack shelf or tray having a base portion with a plurality of wires arranged parallel to each other, the base portion extending in a plane, the rack shelf or tray having an upright portion at an end of the base portion to extend out of the plane, the plastic sleeve covering opposite faces of the upright portion.

6. The display rack enhancer of claim 1, wherein the central formation includes an outward projecting surface that defines the tag holder surface and includes an inclined surface that inclines from the neighboring planar region of the one of the two strips to the outward projecting surface.

7. The display rack enhancer of claim 1, further comprising:
two end surfaces that each meet with the outward projecting surface and the inclined surface and arranged so that a recessed region is bounded by the outward projecting surface, the inclined surface and the two end surfaces.
